(19) United States
(12) Patent Application Publication
(10) Pub. No.: US 2017/0101766 A1
(43) Pub. Date: Apr. 13, 2017

(54) Faucet with Auto-Fill Feature

(71) Applicant: SPECTRUM BRANDS, INC., MIDDLETON, WI (US)

(72) Inventors: Stephen Blizzard, Mission Viejo, CA (US); Chasen Beck, Costa Mesa, CA (US); Elena Gorkovenko, Mission Viejo, CA (US); CREIGHTON HART, Huntington Beach, CA (US)

(21) Appl. No.: 15/284,638

(22) Filed: Oct. 4, 2016

Related U.S. Application Data
(60) Provisional application No. 62/239,558, filed on Oct. 9, 2015.

(51) Int. Cl. E03C 1/05; F16K 21/16; F16K 31/06

(52) U.S. Cl. CPC E03C 1/055; F16K 31/0675; F16K 21/16; E03C 2001/026

(57) ABSTRACT

A kitchen faucet is provided that automatically fills a vessel up to a user-specified level without regard to a specific volume. The faucet illustratively includes a faucet body and a spray head that can be detached from the faucet body, such as a pull-down or pull-out faucet. The faucet illustratively includes a user interface for setting the level at which to fill the vessel (e.g., 20%, 40%, 75%, etc.). The spray head illustratively includes sensor(s) to determine a water level in the vessel in relation to its top edge. This allows a vessel to be filled to a user-specified level regardless of the vessel shape or size.

### RELATED APPLICATIONS

The present application claims the benefit of U.S. Provisional Application Ser. No. 62/239,558 filed Oct. 9, 2015 for a “Faucet with Auto-Fill Feature,” which is hereby incorporated by reference in its entirety.

### TECHNICAL FIELD

The present disclosure relates generally to faucets. In particular, the present disclosure is directed to a kitchen faucet that automatically fills a vessel up to a user-specified level.

### BACKGROUND

Kitchen faucets are used for a wide variety of tasks, such as spraying objects for cleaning, dispensing water for soaking dishes, filling up pots for cooking and many other tasks. In some situations, the faucet will be used to fill a vessel (e.g., pot, cup, sink, etc.) up to a certain level. For example, the user may want to fill the sink up with water for soaking dishes or may want to partially fill a pot for boiling water. In these circumstances, the user will need to monitor the faucet until the vessel is filled to the desired level and then shut-off the water. If the user fails to monitor the faucet and shut it off in time, the fluid level may rise higher than desired or overflow.

Kitchen faucets are increasingly becoming equipped with electronics. Some faucets are equipped with electronics that allow the faucet to be turned on/off in a hands-free manner or by the touching the faucet. Metered faucets are also available in which a specified volume of water can be dispensed, such as 200 ml of water. Although metered faucets can be helpful when the amount of water to be dispensed is known, these types of faucets are ill-equipped to fill a vessel of unknown size up to a certain fluid level, such as filling a sink or pot up to a desired level.

### SUMMARY

According to the present disclosure, a kitchen faucet is provided that automatically fills a vessel up to a user-specified level. The kitchen faucet illustratively includes a faucet body and a spray head that can be detached from the faucet body, such as a pull-down or pull-out faucet. In illustrative embodiments, the faucet includes a user interface for setting the level at which to fill the vessel (e.g., 20%, 40%, 75%, etc.). The spray head illustratively includes sensor(s) to determine a water level in the vessel in relation to its top edge. For example, in some embodiments, the spray head may include a sensor that detects the top edge of the vessel and a sensor that detects the depth of the vessel. This allows a vessel to be filled to a user-specified level regardless of the vessel shape or size. In some embodiments, the faucet automatically shuts-off when an overflow situation is sensed.

In illustrative embodiments, the faucet includes an electronic sensor that detects when the spray head has been detached from the faucet body. When the faucet detects the spray head has been detached, a controller actuates one or more sensors to detect the top of a vessel's side wall and a depth of the vessel. Upon receiving a user-specified fluid fill level, an electronic valve is actuated to dispense water from the spray head. The fluid level in the vessel is monitored to determine when the user-specified fluid fill level is reached. Upon reaching the user-specified fluid fill level, the controller turns off the spray head.

Additional features of the present disclosure will become apparent to those skilled in the art upon consideration of illustrative embodiments including the best mode of carrying out the disclosure as presently perceived.

### BRIEF DESCRIPTION OF THE FIGURES

The detailed description makes reference to the accompanying figures in which:

FIG. 1 is a side perspective view of an example kitchen faucet according to an embodiment of the disclosure;

FIG. 2 is a simplified block diagram of an example control system for controlling dispensing of water from a kitchen faucet according to an embodiment of the disclosure;

FIG. 3 is a diagrammatical view illustratively showing a spray head detecting a vessel side wall and depth according to an embodiment of the disclosure;

FIGS. 4 and 5 are diagrammatical views showing a spray head detecting a vessel side wall and depth according to another embodiment of the disclosure;

FIGS. 6-8 are simplified block diagrams progressively showing filling of a vessel according to an embodiment of the disclosure;

FIG. 9 is a simplified flowchart showing an example operation of the faucet according to an embodiment of the disclosure;

FIGS. 10-14 are screen shots of an example user interface for the kitchen faucet according to an embodiment of the disclosure; and

FIG. 15 is a simplified flowchart showing an example operation of a soak feature of the faucet according to an embodiment of the disclosure.

### DETAILED DESCRIPTION

The figures and descriptions provided herein may have been simplified to illustrate aspects that are relevant for a clear understanding of the herein described devices, systems, and methods, while eliminating, for the purpose of clarity, other aspects that may be found in typical devices, systems, and methods. Those of ordinary skill may recognize that other elements and/or operations may be desirable and/or necessary to implement the devices, systems, and methods described herein. Because such elements and operations are well known in the art, and because they do not facilitate a better understanding of the present disclosure, a discussion of such elements and operations may not be provided herein. However, the present disclosure is deemed to inherently include all such elements, variations, and modifications to the described aspects that would be known to those of ordinary skill in the art.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

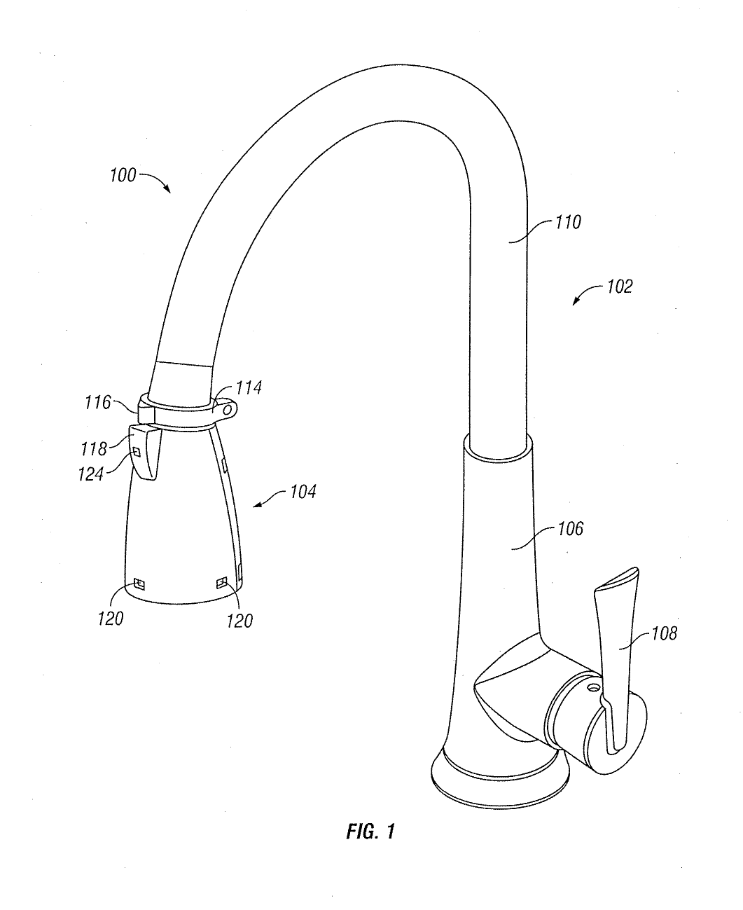

FIG. 1 shows an example kitchen faucet 100 according to an embodiment of this disclosure. Although the kitchen faucet 100 is shown as a pull-down faucet for purposes of example, this disclosure encompasses other types of kitchen faucets, including but not limited to pull-out faucets, and faucets with side spray units. In the example shown, the faucet 100 includes a faucet body 102 and a spray head 104 that can be detached or undocked from the faucet body 102. As is typical, cold and hot water lines (not shown) would be attached to the faucet 100 to be in fluid communication with spray head. As shown, the faucet body 102 includes a base 106 with a handle 108 and a spout 110 extending from the base. Depending on the circumstances, the spout 110 could swivel with respect to the base 106.

As shown, the faucet 100 can be manually controlled (e.g., the temperature and on/off) using the handle 108. In some cases, instead of merely using the handle 108 to manually control the faucet 100, the user could manually adjust the temperature and/or flow rate using an electronic control device, such as by the user actuating a hands-free sensor to adjust flow, manually actuating a touch activation to turn on/off flow or otherwise adjust flow, and/or using one or more buttons or other interface to adjust temperature and/or flow rate. As discussed in more detail below, the faucet 100 includes an electronically controlled dispensing system for dispensing water from the spray head 104 in a vessel at a user-specified level.

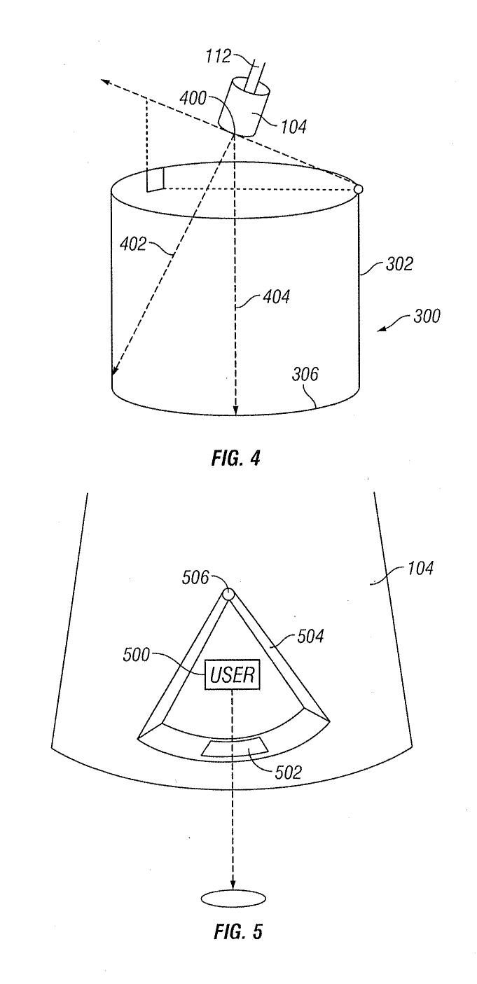

In the embodiment shown, the spout 110 defines an opening for docking the spray head 104. The spray head 104 can be undocked from the spout 110 to extend the reach of the spray head 104. A spray head hose 112 (FIG. 3) provides fluid communication with the water lines. In some embodiments, there is an undocking detection means that detects when the spray head 104 is undocked and/or returned to the spout 110. As shown, the spout 110 includes a collar 114 that is adjacent the spray head 104. The collar 114 may include a magnet 116 that is detected by a magnetic sensor 118, such as a Hall-effect sensor, in the spray head 104 or vice versa. For example, the magnetic sensor 118 could detect the presence and/or absence of a magnetic field generated by the magnet 116 in the collar 114. If the magnetic field is detected, this would mean that the spray head 104 is docked to the spout 110. If the magnetic field is not detected, this would mean that the spray head 104 is undocked from the spout 110. The opposite (docked/undocked) magnetic detection could also be used. Although a magnetic sensor is shown for purposes of example, the undocking detection means could include other types of sensors for detecting undocking/returning of the spray head 104 to the spout 110, including but not limited to optical, infrared, pressure, vibration, capacitive, touch, limit switch, or other proximity sensors.

The spray head 104 includes vessel analysis means for detecting a fluid level in a vessel to be filled compared with a top edge of the vessel. In the example shown, the spray head 104 includes at least one edge proximity sensor 120 for detecting the top of a vessel side wall and at least one depth sensor 122 (FIG. 3) for detecting a depth of the vessel (prior to filling) and current fluid level in the vessel (while filling).

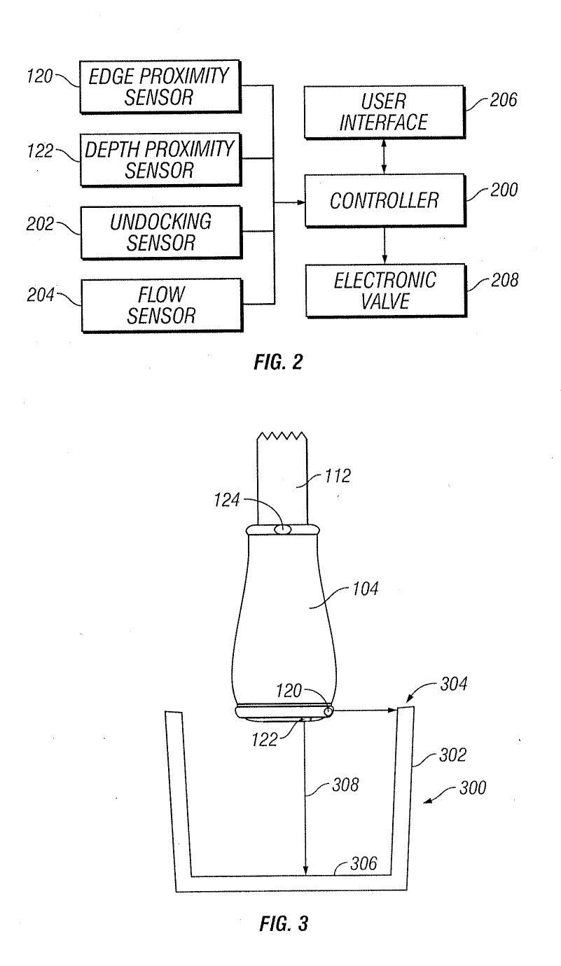

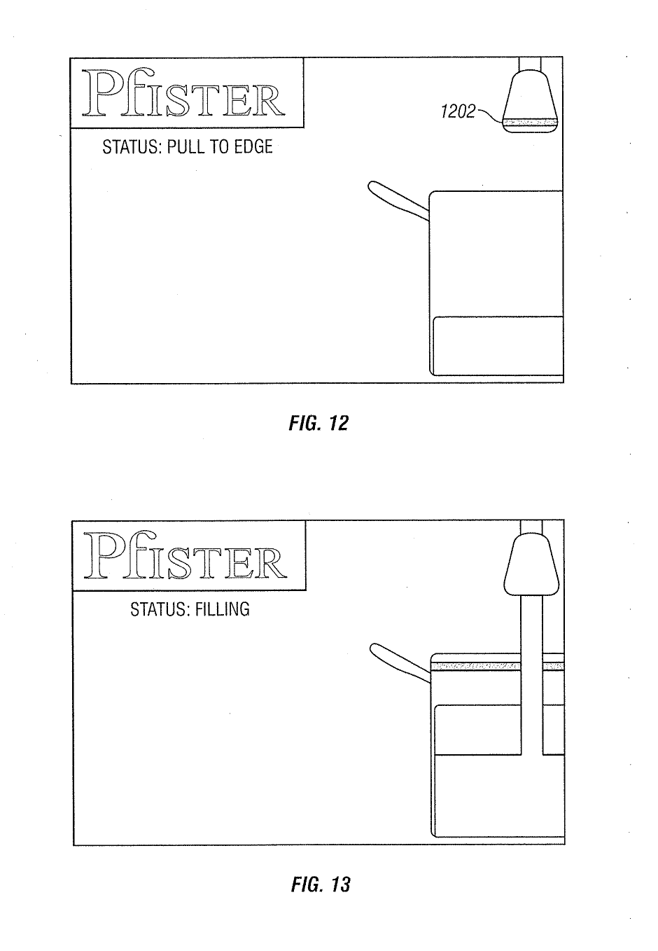

The faucet 100 includes a user interface 206 (FIG. 2) that can be used for input by the user and to display information regarding the faucet 100. By way of example only, the faucet 100 could include a touch-sensitive display, an LED display, an LCD display, audible feedback, haptic feedback and/or one or more indicator lights. In some cases, the faucet 100 could include a wireless communication unit so the user could use an app on a mobile device, such as a smart phone or tablet computer, to communicate with the faucet 100 and use the display on the mobile device as at least a portion of the user interface for the faucet 100 or as the entire user interface for the faucet. In the embodiment shown, the spray head 104 includes a status indicator light 124. For example, the light 124 could change (e.g., solid, blinking, color change, etc.) depending on the status of the faucet 100. FIGS. 10-14 show an example user interface in an embodiment where the faucet 100 includes an integral touch-sensitive display and/or uses a touch-sensitive display of a mobile device via wireless communications.

Referring to FIG. 2, there is shown an example electronic control system for controlling dispensing of water from the faucet 100. In the example shown, the control system includes a controller 200 that receives as inputs at least one edge proximity sensor 120, at least one depth sensor 122, an undocking sensor 202, a flow sensor 204 and a user interface 206. The controller 200 may also control as an output the user interface 206 and an electronic valve 208, such as a solenoid valve, to control dispensing of water at the spray head 104.

The edge proximity sensor 120 is configured to detect a vessel's side wall. In the example shown in FIG. 3, the edge proximity sensor 120 is disposed on a circumferential edge of the spray head 104 to detect proximity along an axis that is generally transverse to the axis in which water is dispensed from the spray head 104. When the spray head 104 is moved to the top of a vessel 300 prior to dispensing water, as with the example shown in FIG. 3, the edge proximity sensor 120 detects when a top portion 304 of the vessel's side wall 302 is reached. By way of example only, the edge proximity sensor 120 could be laser-based, ultrasonic, infrared, optical or other type of proximity sensor suitable for detecting the vessel's side wall.

The edge proximity sensor 120 cooperates with the depth sensor 122 to determine the depth of the vessel 300 to be filled. The depth sensor 122 detects proximity in a direction along the axis in which water is dispensed from the spray head 104. In the example shown, the depth sensor 122 is located on the face of the spray head 104 through which water is dispensed. Accordingly, the user would orient the spray head 104 with respect to the vessel 300 so the depth sensor 122 detects the bottom wall 306 of the vessel 300 as shown by line 308 instead of the vessel's side wall 302. When the edge proximity sensor 120 detects the top portion 304 of the vessel's side wall 302, the depth sensor 122 can detect the total depth of the vessel by detecting the distance to the bottom wall 306 of the vessel. In some embodiments, the depth sensor 122 and the edge proximity sensor 120 could be coplanar so the edge proximity sensor 120 detects the top edge of the vessel 300 when the depth sensor 122 is approximately transversely aligned with the vessel's top edge. In other embodiments, the depth sensor 122 and the edge proximity sensor 120 could be offset by a known distance to detect the total distance from the top 304 of the side wall 302 to the bottom wall 306 based on the offset. By way of example only, the depth sensor 122 could be laser-based, ultrasonic, infrared, optical or other type of proximity sensor suitable for detecting the vessel's depth.

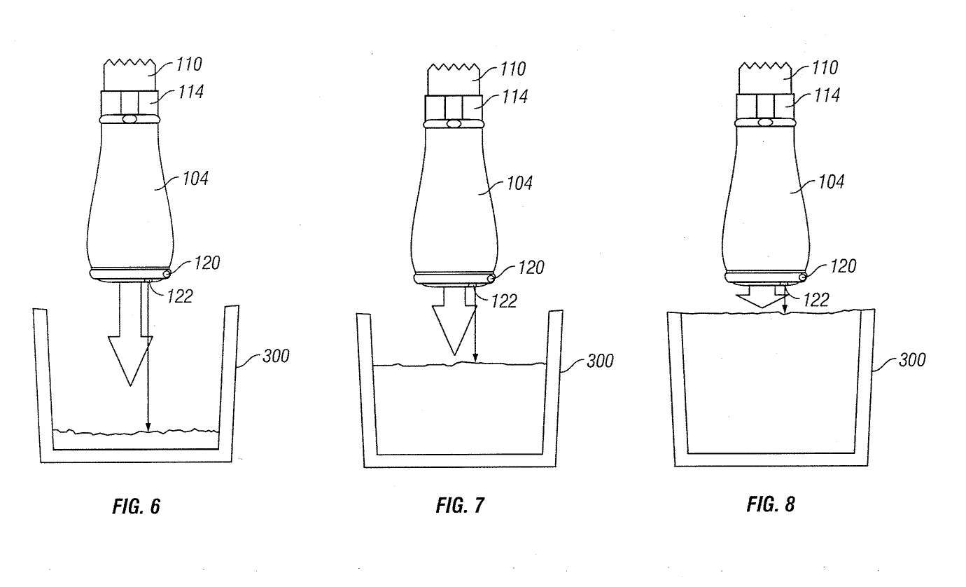

Referring to FIGS. 4 and 5, there is shown embodiments for reducing the introduction of an error in the measurement of the depth sensor 122 when the user orients the spray head 104 in a direction other than towards the vessel's bottom wall 306 (i.e., axis of water flow should be perpendicular to the bottom wall 306). These embodiments encourage the user to correctly orient the spray head 104 so the depth sensor 122 measures the distance to the vessel's bottom wall 306 more accurately.

In one embodiment, shown in FIG. 4, a laser guide 400 could be added to the spray head 104 such that the laser points at the measurement point of the depth sensor 122. In other words, the user would be able to see from the laser guide 400 where the depth sensor 122 is measuring. If the user inadvertently points the spray head 104 towards the vessel's side wall 302 (as shown by line 402), the user would visually see the laser on the side wall 302 and could reorient the spray head 104 so the laser points towards the bottom wall 306 (as shown by line 404).

In another embodiment, shown in FIG. 5, a laser sight could be constructed in such a way that the laser sight does not show through a window unless the spray head 104 is within an acceptable angle. For example, the laser sight 500 could illuminate through a free floating window 502, which could be made of a transparent or translucent material. The free floating window 502 could be mounted on a pendulum swing 504 in front of the laser's 500 path. The pendulum 504 would pivot at pivot point 506 due to gravity and thus move the window 502 in and out of the path of the laser. If the spray head 104 is tilted beyond the acceptable angle the window 502 would no longer be in the path of the laser 500 and blocked. This feedback (i.e., lack of visible laser) would let the user know that the spray head 104 needs to be reoriented and the laser would become visible again on the vessel's bottom wall.

Referring again to FIG. 2, the faucet 100 illustratively includes an undocking sensor 202 for detecting when the spray head 104 is detached from the faucet body 102. As discussed above, in one embodiment, the undocking sensor 202 could include a magnet 116 and magnetic sensor 118 in the spout 110 and spray head 104, or vice versa, for detecting undocking of the spray head 104 and return of the spray head 104. Other embodiments are contemplated in which undocking of the spray head 104 could be detected with a contact switch, proximity sensor or other electronic sensor.

In some embodiments, the faucet 100 includes a flow sensor 204 that could be used for sensing when water is being dispensed from the spray head 104. The flow sensor 204 could sense flow through the faucet 100 mechanically and/or electrically. For example, flow sensing could be sensed with an impeller having one or more magnets and Hall-effect sensor, electronic sensors (e.g., ultrasonic) or other flow sensing devices. In other embodiments, the electronic valve 208 could function as the flow sensor 204 by outputting to the controller 200 whether the valve 208 is open or closed. As discussed below, the flow sensor 204 could be used in cooperation with the depth sensor 122 to detect an overflow situation.

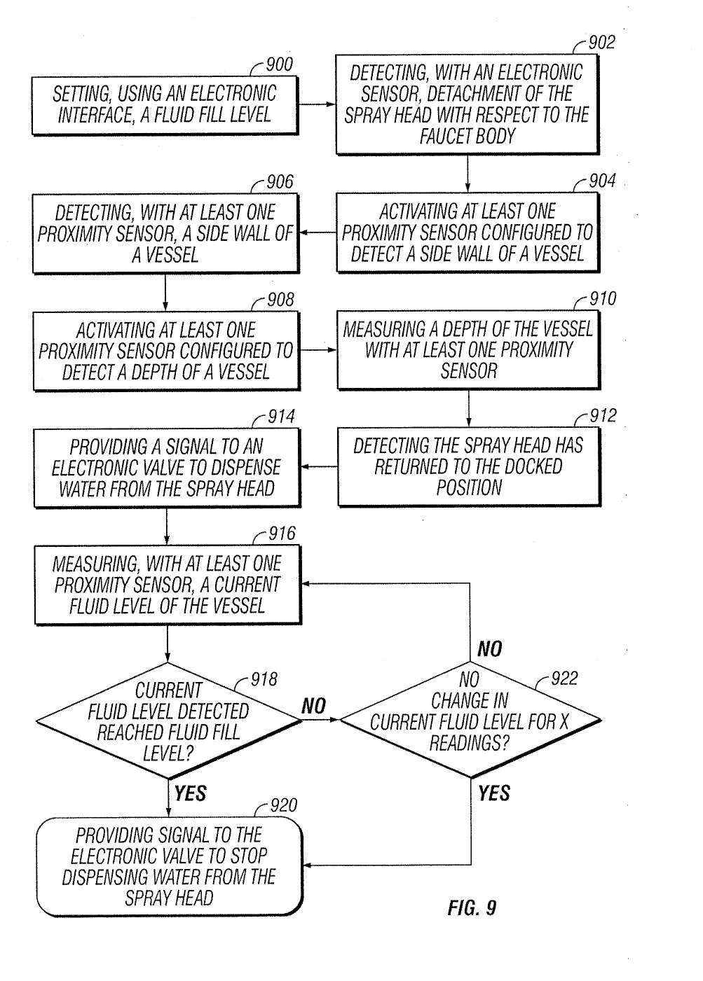

FIGS. 6 and 7 progressively show filling of a vessel 300 after the depth of the vessel 300 has been measured as shown and described above with respect to FIG. 3. With the depth measured, and the user setting the level with which to fill the vessel 300, the faucet 100 will dispense water into the vessel 300. As this happens, the depth sensor 122 will continue to measure a current fluid level of the vessel. The controller 200 will compare the current fluid level measured by the depth sensor 122 with the user-entered fill level to determine whether the electronic valve 208 should be turned off. The spray head 104 will continue to dispense water into the vessel 300 until the current fluid level reaches the user-entered fill level. At that point, the controller 200 will provide a signal to the electronic valve 208 to turn off the water flow. In some embodiments, as shown in FIG. 8, the faucet 100 may include overflow protection. For example, if the controller 200 determines that the depth sensor 122 has had the same measurement for a predetermined number of reads or predetermined time period, even though the flow sensor 204 indicates water is still flowing from the spray head 104, this indicates an overflow situation and the controller 200 will provide a signal to the electronic valve 208 to turn off the faucet 100.

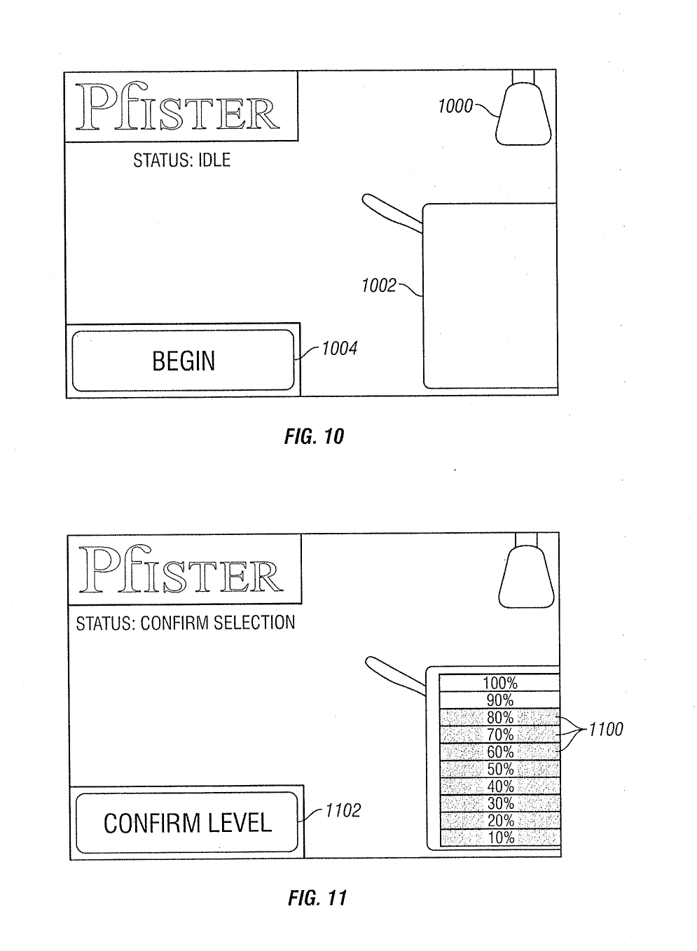

FIG. 9 is a simplified flow chart showing an example operation of the faucet 100 during use. In this example, the method begins with Block 900 in which the fluid fill level is set based on input through the user interface 206. FIG. 10 shows an example user interface 206. In this example, the user is presented with a simplified graphic of a spray head 1000 over a pot 1002 to be filled. In some embodiments, the operation could begin by prompting a user to begin the process, such as selecting a button 1004 labeled “Begin.” Upon selecting “Begin,” the user could be presented with an interface for selecting a fluid fill level, such as shown in FIG. 11. In this example, the user is presented with a plurality of potential fill levels 1100, defined as percentages of a complete fill, for the user to choose. The example user interface shown includes a button 1102 labeled “Confirm Level” for the user to confirm the selected fluid fill level. However, this interface is shown merely for example purposes; one skilled in the art should appreciate there are numerous ways of entering fluid fill levels through an interface.

Upon receiving the user-selected fluid-fill level, the process moves to Block 902 in which the undocking sensor 202 detects detachment of the spray head 104 with respect to the faucet body 102, such as detachment from the spout 110. Once the undocking of the spray head 104 is detected, the process moves to Block 904 in which the edge proximity sensor 120 is activated to start sensing for a side wall of the vessel. The user moves the spray head 104 to the top of the vessel, which allows the top of the vessel's side wall to be detected. (Block 906). For example, the user could then be prompted to pull the spray head 104 to the edge of the vessel to be filled as shown in the example user interface of FIG. 12. In the example interface shown, an interface element 1202 could change colors to indicate the vessel's side wall has been detected. As mentioned above, however, there are numerous manners of providing feedback to the user regarding detection of the vessel's sidewall, such as illuminating a light 124, haptic feedback, audible feedback, such as voice output, beep, etc.

With the position of the top portion of the vessel's side wall identified by the edge proximity sensor 120, the process moves to Block 908 in which the depth sensor 122 is activated. Although the process in FIG. 9 shows the edge proximity sensor 120 and depth sensor 122 activated separately to save power, one skilled in the art should appreciate that these sensors 120, 122 could be activated together depending on the circumstances. With the depth sensor 122 activated, the depth of the vessel can be measured. (Block 910). Thus, the depth of the vessel with respect to the vessel's top edge can be determined. For example, if the user selected “40%” as the fluid fill level, the fluid fill depth can be calculated as 40% of the measured vessel depth.

The process next steps to Block 912 in which the return of the spray head to the docked position is detected by the undocking sensor 202. For example, the user may be prompted to redock the spray head 104 via the user interface 202 upon determining the vessel's depth in the user interface 202. By redocking the spray head 104, the position of the spray head 104 is stationary and acts as a reference point to get consistent readings from the depth sensor 122.

The process next moves to Block 914 in which the controller 200 provides a signal to the electronic valve 208 to open so water is dispensed through the spray head 104, which starts the filling of the vessel. FIG. 13 shows an example interface in which the filling status could be visually shown to the user. As the vessel is being filled with water, the process moves to Block 916 in which the current fluid level is measured by the depth sensor 122. The current fluid level is compared with the user-selected fluid fill level. (Block 918). If the user-selected fluid fill level is reached, the process ends with Block 920 in which the controller 200 provides a signal to the electronic valve 208 to turn off the water flow. FIG. 14 shows an example user interface that indicates to the user that filling of the vessel is complete. If the user-selected fluid fill level has not yet been reached, the process steps to Block 922 in which the controller 200 determines whether there has been no change in the current fluid level for a certain number of readings or time even though the flow sensor 204 indicates water is still flowing to the spray head 104. If this is true, the controller 200 provides a signal to the electronic valve 208 to turn off the water flow (Block 920) because this indicates an overflow situation. Otherwise, the process moves back to Block 916 and filling continues.

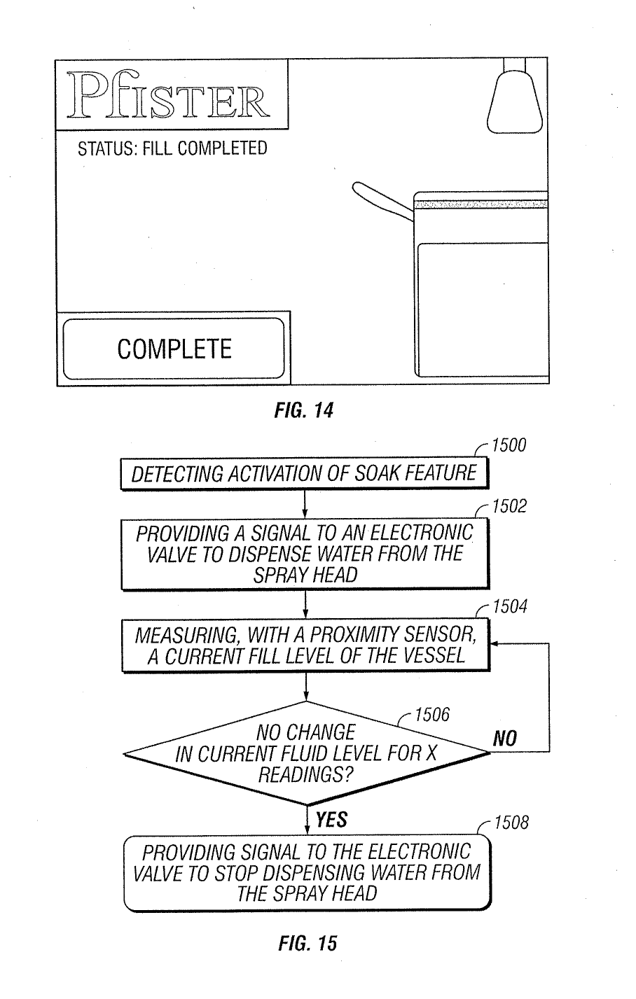

In some embodiments, the faucet 100 may include a “soak” feature. The soak feature allows the user to completely fill a vessel, such as a dish, to let it soak with the intent of loosening the food to allow for easier cleaning without needing to specifically select a level. Likewise, the user may activate the soak feature to completely fill the sink with water to let several dishes soak. FIG. 15 a simplified flow chart showing an example operation of the faucet 100 when the soak feature is activated. The process starts with Block 1500 in which the activation of soak feature is detected. By way of example, the soak feature could be activated with the user interface 202, such as with a button, lever, or switch. In some cases, the soak feature could be activated with a touch interface, such as by touching a “button” on a touch-sensitive screen. The process next moves to Block 1502 in which the controller 200 provides a signal to the electronic valve 208 to turn on water to the spray head 104. The depth sensor 122 detects changes in a fluid level in the vessel (Block 1504), but unlike the process described with respect to FIG. 9, this reading is not used to determine a depth relative to the top edge of the vessel. Instead, the depth sensor 122 is merely used to determine whether any change in fluid level has occurred. (Block 1506). If the fluid level continues to rise, this means the vessel is not completely filled and the process moves back to Block 1504 to continue monitoring the fluid level. If the fluid level is no longer rising, the process moves to Block 1508 in which the controller 200 provides a signal to the electronic valve 208 to turn off water to the spray head 104 because the vessel is completely filled. In some embodiments, soak feature may not completely fill to vessel, but could be a preset level that substantially fills the vessel, such as 70%-95% of the vessel.

### Examples

Illustrative examples of the faucet disclosed herein are provided below. An embodiment of the faucet may include any one or more, and any combination of, the examples described below.

Example 1 is a kitchen faucet including a faucet body and a spray head configured to dispense water generally along a dispensing axis. The spray head is movable with respect to the faucet body. The faucet includes an interface configured to set a user-specified level at which a vessel will be filled. The user-specified level is identified on the interface as a level of a vessel to be filled without regard to a specific fluid volume. An electronic valve is configured to control flow through the spray head. The faucet also includes a controller configured to control the electronic valve to fill the vessel to the user-specified level.

In Example 2, the subject matter of Example 1 is further configured such that the user-specified level is identified as a fill level with respect to a top edge of the vessel.

In Example 3, the subject matter of Example 2 is further configured such that the user-specified level is represented as a percentage.

In Example 4, the subject matter of Example 2 is further configured such that at least one electronic sensor is in electrical communication with the controller that is configured to detect the fill level with respect to the top edge of the vessel.

In Example 5, the subject matter of Example 4 is further configured such that the at least one electronic sensor is movable concomitant with the spray head.

In Example 6, the subject matter of Example 5 is further configured such that the at least one electronic sensor is integral with the spray head.

In Example 7, the subject matter of Example 1 is further configured such that a laser guide associated with the spray head for generating a laser beam in a direction substantially coaxial to the dispensing axis.

In Example 8, the subject matter of Example 7 is further configured such that the laser guide is movable concomitant with the spray head.

Example 9 is a kitchen faucet including a faucet body and a spray head configured to dispense water generally along a dispensing axis. The spray head is detachably coupled to the faucet body. An interface is provided that is configured to set a user-specified level at which a vessel will be filled. The faucet includes a first proximity sensor configured to detect proximity along an axis transverse to the dispensing axis and a second proximity sensor configured to detect proximity along the dispensing axis. An electronic valve is provided that is configured to control flow through the spray head. The faucet includes a controller configured to control the electronic valve based on the first proximity sensor and the second proximity sensor to fill a vessel to the user-specified level. The first proximity sensor and the second proximity sensor are integral with the spray head.

In Example 10, the subject matter of Example 9 is further configured with a flow sensor configured to detect water flowing through the spray head.

In Example 11, the subject matter of Example 10 is further configured such that the controller closes the electronic valve when the flow sensor detects water flowing to the spray head while there is no change in a reading from the second proximity sensor.

In Example 12, the subject matter of Example 9 is further configured such that the spray head includes a circumferential edge and the first proximity sensor is located along the circumferential edge.

In Example 13, the subject matter of Example 12 is further configured such that the circumferential edge defines an opening through which at least a portion of the first proximity sensor extends.

In Example 14, the subject matter of Example 12 is further configured such that the first proximity sensor includes at least two proximity sensors spaced apart along the circumferential edge of the spray head.

In Example 15, the subject matter of Example 12 is further configured such that the second proximity sensor is coaxial with the dispensing axis.

In Example 16, the subject matter of Example 9 is further configured such that the interface is configured to present a plurality of predetermined levels from which a user can select to fill a vessel.

In Example 17, the subject matter of Example 16 is further configured such that at least a portion of the predetermined levels are defined as a percentage.

In Example 18, the subject matter of Example 9 is further configured with an undocking sensor configured to detect whether the spray head is detached from the faucet body.

In Example 19, the subject matter of Example 18 is further configured such that the undocking sensor includes a magnet associated with either the faucet body or the spray head and a magnetic sensor associated with the other of the spray head or the faucet body.

In Example 20, the subject matter of Example 19 is further configured such that when the spray head is attached to the faucet body, the magnet is located proximate the magnetic sensor such that a magnetic field of the magnet can be detected by the magnetic sensor.

In Example 21, the subject matter of Example 20 is further configured such that when the spray head is detached from the faucet body, the magnet is located away from the magnetic sensor such that the magnetic field of the magnet cannot be detected by the magnetic sensor.

In Example 22, the subject matter of Example 18 is further configured such that the controller is configured to actuate the first proximity sensor and/or the second proximity sensor when the undocking sensor detects that the spray head is detached from the faucet body.

In Example 23, the subject matter of Example 9 is further configured such that the interface identifies whether the first proximity sensor has detected an edge of a vessel.

In Example 24, the subject matter of Example 23 is further configured such that the interface identifies by audible, haptic, and/or visual feedback that the first proximity sensor has detected an edge of a vessel.

In Example 25, the subject matter of Example 24 is further configured such that the interface generates an instruction to reattach the spray head when the first proximity sensor detects an edge of a vessel.

In Example 26, the subject matter of Example 9 is further configured to include a laser with a beam aligned with the dispensing axis.

In Example 27, the subject matter of Example 26 is further configured to include a swing with a window pivotally connected to the spray head, wherein the swing pivots along a first angular range that blocks the beam and a second angular range in which the beam can pass through the window.

Example 28 is a kitchen faucet with a faucet body and a spray head configured to dispense water generally along a dispensing axis. The spray head is detachably coupled to the faucet body. An interface is provided that is configured to set a user-specified level at which a vessel will be filled. The faucet includes vessel analysis means for detecting a fluid level in a vessel compared with a top edge of the vessel. An electronic valve is provided that is configured to control flow through the spray head. The faucet includes a controller configured to control the electronic valve based on the vessel analysis means to fill the vessel to the user-specified level.

In Example 29, the subject matter of Example 28 is further configured with a flow sensor configured to detect water flowing to the spray head.

In Example 30, the subject matter of Example 29 is further configured such that the controller closes the electronic valve when the flow sensor detects water flowing to the spray head while there is no change in a reading from the second proximity sensor.

In Example 31, the subject matter of Example 28 is further configured such that the spray head includes a circumferential edge and at least a portion of the vessel analysis means is located along the circumferential edge.

In Example 32, the subject matter of Example 31 is further configured such that the circumferential edge defines an opening through which at least a portion of the vessel analysis means extends.

In Example 33, the subject matter of Example 31 is further configured such that the at least a portion of the vessel analysis means is coaxial with the dispensing axis.

In Example 34, the subject matter of Example 28 is further configured such that the interface is configured to present a plurality of predetermined levels from which a user can select to fill a vessel.

In Example 35, the subject matter of Example 34 is further configured such that at least a portion of the predetermined levels are defined as a percentage.

In Example 36, the subject matter of Example 28 is further configured with undocking detection means for detecting whether the spray head is detached from the faucet body.

In Example 37, the subject matter of Example 36 is further configured such that the undocking detection means includes a magnet associated with either the faucet body or the spray head and a magnetic sensor associated with the other of the spray head or the faucet body.

In Example 38, the subject matter of Example 37 is further configured such that when the spray head is attached to the faucet body, the magnet is located proximate the magnetic sensor such that a magnetic field of the magnet can be detected by the magnetic sensor.

In Example 39, the subject matter of Example 38 is further configured such that when the spray head is detached from the faucet body, the magnet is located away from the magnetic sensor such that the magnetic field of the magnet cannot be detected by the magnetic sensor.

In Example 40, the subject matter of Example 37 is further configured such that the controller actuates the vessel analysis means when the undocking detection means detects that the spray head is detached from the faucet body.

In Example 41, the subject matter of Example 28 is further configured such that the interface identifies whether the vessel analysis means has detected an edge of a vessel.

In Example 42, the subject matter of Example 41 is further configured such that the interface identifies by audible, haptic, and/or visual feedback that the vessel analysis means has detected an edge of a vessel.

In Example 43, the subject matter of Example 42 is further configured such that the interface generates an instruction to reattach the spray head when the vessel analysis means detects an edge of a vessel.

Example 44 provides a method of controlling water flow from a kitchen faucet. The method includes providing a kitchen faucet including a faucet body and a spray head configured to dispense water generally along a dispensing axis in which the spray head is detachably coupled to the faucet body. An electronic sensor detects detachment of the spray head with respect to the faucet body. In response to detection that the spray head has been detached from the faucet body, at least one proximity sensor configured to detect a side wall of a vessel and a depth of the vessel is actuated. A side wall of the vessel is detected with the at least one proximity sensor. The depth of the vessel is measured responsive to detection of a side wall of the vessel. A fluid fill level is set at which a vessel is to be filled via an electronic interface. A signal is provided to an electronic valve to dispense water from the spray head. A current fluid level of a vessel is monitored with the at least one proximity sensor. In response to detection of the current fluid level reaching the fill fluid level by the at least one proximity sensor, a signal is provided to the electronic valve to stop dispensing water from the spray head.

In Example 45, the subject matter of Example 44 is further configured by monitoring flow of water to the spray head.

In Example 46, the subject matter of Example 45 is further configured by actuating the electronic valve to stop water dispensing from the spray head responsive to detection that water is flowing to the spray head and the current fluid level has been the same for: (1) a predetermined time period and/or (2) a predetermined number of readings.

In Example 47, the subject matter of Example 44 is further configured by identifying detection of the side wall of the vessel with audible, haptic and/or visual feedback.

In Example 48, the subject matter of Example 44 is further configured by displaying an instruction to detach the spray head from the faucet body and move the spray head into the vessel on an electronic display associated with the faucet.

In Example 49, the subject matter of Example 44 is further configured by displaying an instruction to reattach the spray head to the faucet body on an electronic display associated with the faucet responsive to the detection of the side wall.

Example 50 provides a method of filling a vessel using a kitchen faucet. The method includes the step of providing a kitchen faucet including an electronic valve configured to control flow of water from the faucet. The method includes detecting activation of a soak feature with at least one electronic sensor. In response to detecting activation of the soak feature, a signal is provided to the electronic valve to dispense water from the kitchen faucet. The current fluid level in a vessel to be filled is monitored by at least one electronic sensor. A signal is provided to the electronic valve to shut off flow of water from the kitchen faucet responsive to the current fluid level being unchanged: (1) for a predetermined period of time; and/or (2) for a predetermined number of readings of the current fluid level.

1. A faucet comprising:
a faucet body;
a spray head configured to dispense water generally along a dispensing axis, wherein the spray head is movable with respect to the faucet body;
an interface configured to set a user-specified level at which a vessel will be filled, wherein the user-specified level is identified on the interface as a level of a vessel to be filled without regard to a specific fluid volume;
an electronic valve configured to control flow through the spray head; and
a controller configured to control the electronic valve to fill the vessel to the user-specified level.

2. The faucet of claim 1, wherein the user-specified level is identified as a fill level with respect to a top edge of the vessel.

3. The faucet of claim 2, wherein the user-specified level is represented as a percentage.

4. The faucet of claim 2, further comprising at least one electronic sensor in electrical communication with the controller that is configured to detect the fill level with respect to the top edge of the vessel.

5. The faucet of claim 4, wherein the at least one electronic sensor is movable concomitant with the spray head.

6. The faucet of claim 5, wherein the at least one electronic sensor is integral with the spray head.

7. The faucet of claim 1, further comprising a laser guide associated with the spray head for generating a laser beam in a direction substantially coaxial to the dispensing axis.

8. The faucet of claim 7, wherein the laser guide is movable concomitant with the spray head.

9. A kitchen faucet comprising:
a faucet body;
a spray head configured to dispense water generally along a dispensing axis, wherein the spray head is detachably coupled to the faucet body;
an interface configured to set a user-specified level at which a vessel will be filled;
a first proximity sensor configured to detect a proximity along an axis transverse to the dispensing axis;
a second proximity sensor configured to detect a proximity along the dispensing axis;
an electronic valve configured to control flow through the spray head;
a controller configured to control the electronic valve based on the first proximity sensor and the second proximity sensor to fill a vessel to the user-specified level; and
wherein the first proximity sensor and the second proximity sensor are integral with the spray head.

10. The kitchen faucet of claim 9, further comprising a flow sensor configured to detect water flowing through the spray head, wherein the controller is configured to close the electronic valve when the flow sensor detects water flowing to the spray head when there is no change in a reading from the second proximity sensor.

11. The kitchen faucet of claim 9, wherein the spray head includes a circumferential edge and the first proximity sensor is located along the circumferential edge, wherein the circumferential edge defines an opening through which at least a portion of the first proximity sensor extends.

12. The kitchen faucet of claim 11, wherein the first proximity sensor includes at least two proximity sensors spaced apart along the circumferential edge of the spray head.

13. The kitchen faucet of claim 12, wherein the second proximity sensor is coaxial with the dispensing axis.

14. The kitchen faucet of claim 9, wherein the interface is configured to present a plurality of predetermined levels from which a user can select to fill a vessel, wherein at least a portion of the predetermined levels are defined as a percentage.

15. The kitchen faucet of claim 9, further comprising an undocking sensor configured to detect whether the spray head is detached from the faucet body, wherein the undocking sensor includes a magnet associated with either the faucet body or the spray head and a magnetic sensor associated with the other of the spray head or the faucet body, wherein when the spray head is attached to the faucet body, the magnet is located proximate the magnetic sensor such that a magnetic field of the magnet can be detected by the magnetic sensor, wherein when the spray head is detached from the faucet body, the magnet is located away from the magnetic sensor such that the magnetic field of the magnet cannot be detected by the magnetic sensor.

16. The kitchen faucet of claim 15, wherein the controller is configured to actuate the first proximity sensor and/or the second proximity sensor when the undocking sensor detects that the spray head is detached from the faucet body.

17. The kitchen faucet of claim 9, wherein the interface is configured to identify whether the first proximity sensor has detected an edge of a vessel, wherein the interface is configured to identify by audible, haptic, and/or visual feedback that the first proximity sensor has detected an edge of a vessel.

18. The kitchen faucet of claim 17, wherein the interface is configured to generate an instruction to reattach the spray head to the faucet body when the first proximity sensor detects an edge of a vessel.

19. The kitchen faucet of claim 9, further comprising a laser with a beam generally aligned with the dispensing axis.

20. The kitchen faucet of claim 26, further comprising a swing with a window pivotally connected to the spray head, wherein the swing pivots along a first angular range that blocks the beam and a second angular range in which the beam can pass through the window.
